(19) United States
(12) Patent Application Publication
(10) Pub. No.: US 2018/0258670 A1
(43) Pub. Date: Sep. 13, 2018

(54) Motor Vehicle Door Inside Door Opening Mechanism

(71) Applicant: GM GLOBAL TECHNOLOGY OPERATIONS LLC, Detroit, MI (US)

(72) Inventor: Lars Marzahl, Ruesselsheim (DE)

(73) Assignee: GM GLOBAL TECHNOLOGY OPERATIONS LLC, Detroit, MI (US)

(21) Appl. No.: 15/913,991

(22) Filed: Mar. 7, 2018

(30) Foreign Application Priority Data
Mar. 7, 2017 (DE) 102017002186.4

(51) Int. Cl. E05B 79/22; E05B 85/12; E05B 83/36; B60R 13/02

(52) U.S. Cl. CPC E05B 79/22; E05B 85/12; B60J 5/04; B60R 13/0243; E05B 83/36

(57) ABSTRACT

An interior door opening mechanism for a motor vehicle door includes a bearing base and a lever for actuating a door latch pivoted to a bearing base. The bearing base includes an interface for non-destructively and detachably coupling the door opening mechanism with an interior door paneling of the motor vehicle door.

### CROSS-REFERENCE TO RELATED APPLICATION

This application claims priority to German Patent Application No. 102017002186.4, filed Mar. 7, 2017, which is incorporated herein by reference in its entirety.

### TECHNICAL FIELD

The present disclosure pertains to an inside or interior door opening mechanism and an inside or interior door paneling for a motor vehicle door, a door unit configuration and a motor vehicle with the interior door opening mechanism and interior door paneling as well as a method for joining together the interior door opening mechanism and interior door paneling.

### BACKGROUND

Inside or interior door opening mechanisms generally include a lever for actuating a door latch pivoted to a bearing base. The lever may be configured as an integrally designed recessed grip, which is introduced into a recess of an inside or interior door paneling from a front side facing the vehicle interior and joined thereto by fusing pins that are integrally designed with the bearing base.

### SUMMARY

The present disclosure provides an improved door unit and assembly or disassembly thereof. The door unit may be configured as a either a front or rear door for a motor vehicle such as a passenger car including an inside or interior door opening mechanism and inside or interior door paneling, which are or will be non-destructively and detachably and/or positively and/or frictionally secured together with a plug connection, which improves assembly and/or disassembly, especially as compared to conventional connections. In an embodiment, structurally identical interior door opening mechanisms can be used for both front and rear doors.

In an embodiment of the present disclosure, an interior door opening mechanism includes a bearing base and a lever for actuating a door latch, which to this end is pivoted to the bearing base. The bearing base may be a single piece or multiple piece part.

In an embodiment, the lever is mounted to the bearing base by a bearing axle, which is secured to the bearing base, in particular inserted therein. Additionally or alternatively, the lever in one embodiment is preloaded in an unactuated position by a spring such as a torsion spring. As a result, it is possible to improve assembly and/or disassembly and/or handling of the lever.

In an embodiment of the present disclosure, the bearing base has an integrally configured interface for coupling the bearing base or interior door opening mechanism with the interior door panel or counter-interface thereof to provide a non-destructive and detachable and/or positive and/or frictional plug connection therebetween. Accordingly, the interior door paneling in one embodiment of the present disclosure includes an integrally configured counter-interface for coupling the interior door paneling with the interior door opening mechanism and/or its bearing base to provide a non-destructive and detachable and/or positive and/or frictional plug connection therebetween. As a result, it is possible to improve the assembly and/or disassembly of the interior door opening mechanism or interior door paneling.

In an embodiment, the lever in an unactuated position protrudes over the bearing base in a longitudinal direction (of extension), by at least 10% and/or at most 75% of its length.

In an embodiment, the interior door paneling additionally or alternatively has an integrally designed recessed grip, which is overlapped by the lever of the interior door opening mechanism in an unactuated position at least partially in a longitudinal direction when the interior door opening mechanism is or joined with the interior door paneling, in particular correspondingly dimensioned and/or arranged. In an embodiment, the lever is arranged on a lower edge of the recessed grip.

In an embodiment, the interior door paneling additionally or alternatively has an opening, which is passed through by the interior door opening mechanism when the interior door opening mechanism is joined with the interior door paneling or is set up for this purpose.

In an embodiment, the bearing base may in this way be made compact in design, thereby reducing its weight and/or improving its assembly and/or disassembly and/or the handling of the lever.

In an embodiment, the bearing base or interface or interior door opening mechanism is inserted from a rear side of the interior door paneling facing away from the vehicle interior into the interior door paneling or counter-interface or set up for this purpose. As a result, it possible to improve a seal therebetween.

In an embodiment, the interface of the bearing base includes one or more latching projections, which may be integrally configured, in particular casted, arranged and/or distributed over a periphery of the bearing base or its interface. The interface may also include one or more latching depressions or openings arranged and/or distributed over a periphery of the bearing base or its interface. The counter-interface of the interior door paneling may include one or more latching depressions or openings arranged and/or distributed over a periphery of the counter-interface. The counter-interface may also include one or more latching projections, which may be integrally configured, in particular casted, arranged and/or distributed over a periphery of the counter-interface. The interface and counter-interface are configured to latch together to form the plug connection. In an embodiment, the plug connection is a latching connection such that the interior door opening mechanism and interior door paneling or interface and counter-interface are latched together. As a result, it is possible to improve the strength and/or assembly and/or disassembly.

In an embodiment, the interface of the bearing base has one or more guiding rails, which are integrally configured, in particular casted, arranged and/or distributed over a periphery of the bearing base or interface. One or more guiding grooves, in particular slits, may also be arranged and/or distributed over a periphery of the bearing base or interface, in the insertion direction of the plug. The counter-interface of the interior door paneling has one or more guiding grooves, in particular slits, arranged and/or distributed over a periphery of the counter-interface. One or more guiding rails, which are integrally configured, in particular casted, are arranged and/or distributed over a periphery of the counter-interface. The guiding rails formed on the interface and the guiding grooves formed on the counter-interface (and vis-a-versa) engage into each other and guide the interior door opening mechanism during assembly onto the interior door paneling and/or fix them in place in the joined state, in particular transverse to the insertion direction. As a result, it is possible to improve the strength and/or assembly and/or disassembly.

In an embodiment, the counter-interface of the interior door paneling includes a frame having an opening configured to receive the bearing base. The frame including the opening may be integral with the interior door panel or may be positively and/or frictionally secured thereto. In particular, the bearing base and the frame of the interior door paneling which receives the bearing base, is set up for this purpose may have congruent contours. As a result, it is possible to improve the strength and/or assembly and/or disassembly.

In an embodiment, the counter-interface of the interior door paneling, and more particularly, the frame, additionally or alternatively includes one or more expansion joints, in particular slits, which expand to latch and/or positively and/or frictionally receive the bearing base. As a result, it is possible to improve the strength, seal and/or assembly and/or disassembly.

In an embodiment, the counter-interface of the interior door paneling additionally or alternatively include at least one stop in the insertion direction for positively limiting an insertion of the interior door opening mechanism or interface. As a result, it is possible to improve the strength, seal and/or assembly and/or disassembly.

### BRIEF DESCRIPTION OF THE DRAWINGS

The present disclosure will hereinafter be described in conjunction with the following drawing figures, wherein like numerals denote like elements.

FIG. 1 show a door unit configuration of a motor vehicle with an inside or interior door opening mechanism and an inside or interior door paneling according to an embodiment of the present disclosure as viewed in perspective from a door panel rear side;

FIG. 2 shows the door unit configuration as viewed in perspective from a door panel front side;

FIG. 3 shows the interior door opening mechanism and interior door paneling as viewed in perspective from a door panel rear side in an unassembled or expanded state; and

FIG. 4 is a perspective, expanded view of a bearing base and a lever of the interior door opening mechanism.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

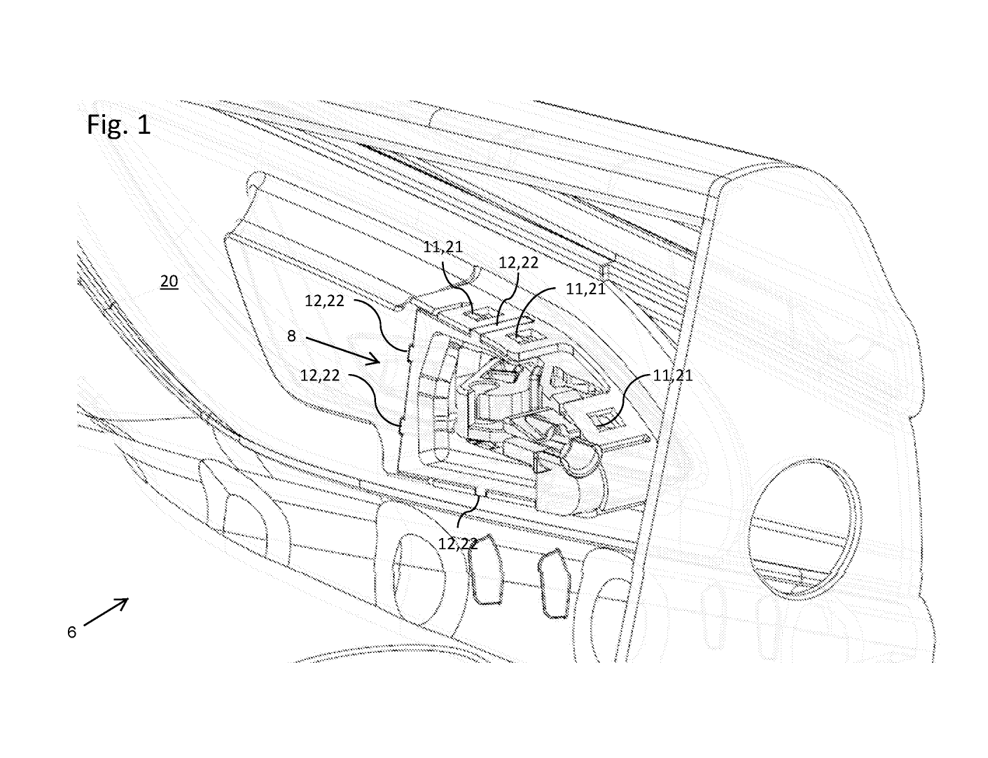

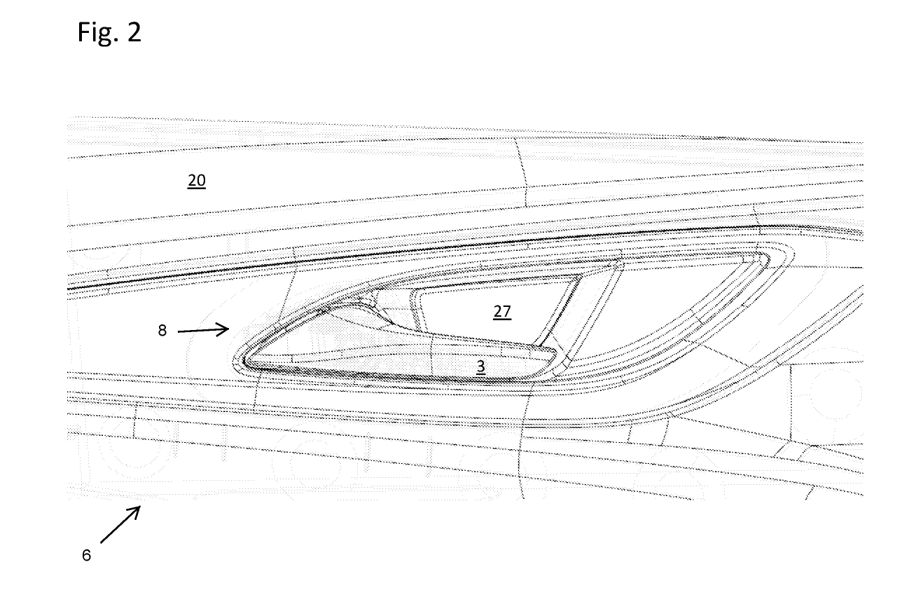

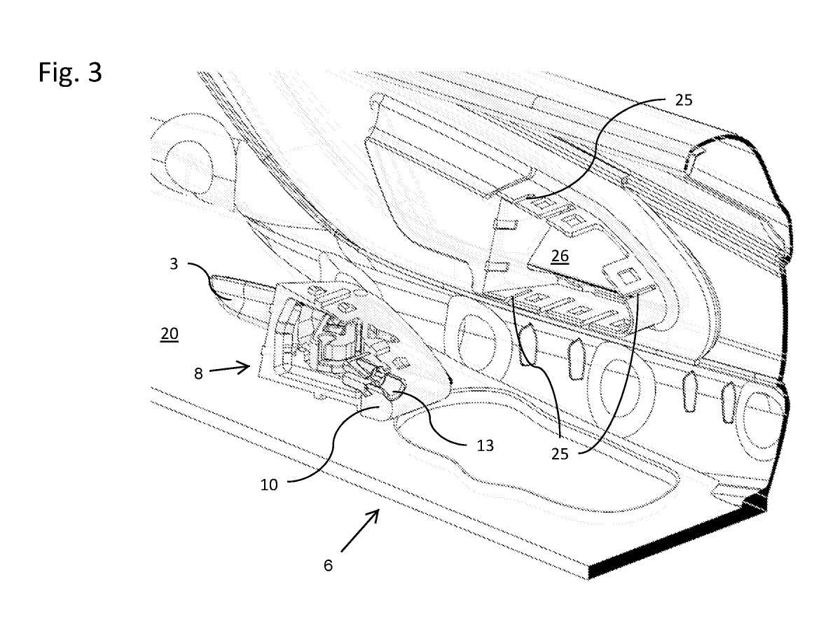

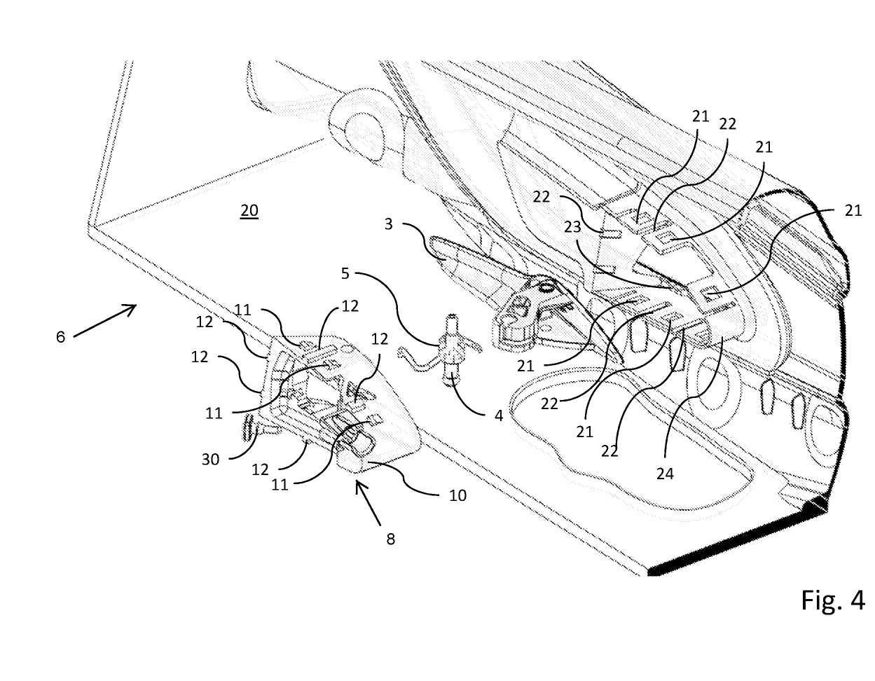

FIG. 1 shows a door unit configuration 6 of a motor vehicle with an inside or interior door opening mechanism 8 and an inside or interior door paneling 20 connected therewith according to an embodiment of the present disclosure as viewed in perspective from a door panel rear side, while FIG. 3 presents the same view of an interior door opening mechanism 8 and interior door paneling 20 in an expanded state. FIG. 2 presents the door unit configuration 6 as viewed from a door panel front side. FIG. 4 presents a perspective, expanded view of the interior door opening mechanism 8.

As evident in particular from FIG. 3, 4, the interior door opening mechanism 8 has a one-part bearing base 10 and a lever 3 for actuating a door latch above a cable (not shown) that runs in a connection 13 (see FIG. 3) of the bearing base 10, is secured to the lever 3, and is pivoted by a bearing axle 4 to the bearing base 10, which is inserted into the bearing base 10. The lever 3 is preloaded by a torsion spring 5 in a non-activated position (see FIG. 2).

The bearing base 10 has an integrally configured interface, with which the bearing base 10 or interior door opening mechanism 8 is non-destructively and detachably coupled with the interior door paneling 20 or a counter-interface of the interior door paneling 20. Accordingly, the interior door paneling 20 has this integrally configured counter-interface.

To this end, the interface of the bearing base 10 has several integrally designed projections 11 arranged and distributed over a periphery of the bearing base 10, while the counter-interface of the interior door paneling 20 has several openings 21 arranged and distributed over the periphery and which with the projection 11 to detachably secure interior door opening mechanism 8 and interior door paneling 20 together, as evident from a combined review of FIG. 1, 3.

In addition, the interface of the bearing base 10 has several integrally configured guide rails 12 arranged and distributed over the periphery in the insertion direction of the latching connection (from the bottom left to top right on FIG. 3), and the counter-interface of the interior door paneling 20 has several guide grooves 22 arranged and distributed over a periphery. The guide rails 12 and the guide grooves 22 which engage into each other and guide the interior door opening mechanism 8 during assembly to the interior door paneling 20, and fix these components in place transversely with respect to the insertion direction in the joined state.

The interior door opening mechanism 8, bearing base 10 or the interface associated therewith is inserted from a rear side of the interior door paneling 20 facing away from the vehicle interior into the interior door paneling 20.

The guide rails 12 engaging into the guide grooves 22 here guide the bearing base 10 until the bearing base 10 rests against a stop 23 in the insertion direction. The stop 23 positively limits an insertion, and the latching projections 11 of the interface of the bearing base 10 latch into or with the latching openings 21 of the interior door paneling 20. As a result, the interior door opening mechanism 8 is non-destructively and detachably plugged with the interior door paneling 20.

As evident from FIG. 3, the lever 3 in an unactuated position protrudes over the bearing base 10 in a direction of longitudinal extension, and with the interior door opening mechanism 8 and interior door paneling 20 in a connected state overlaps a recessed grip 27, which is integrally configured with the interior door paneling 20, and on whose lower edge the lever 3 is arranged (see FIG. 2).

The interior door paneling 20 has an integrally configured frame 24 open on two sides, in which the latching openings 21 and guide grooves 22 are arranged or formed, and which receives the bearing base 10 with a clearance or positively and/or frictionally. To this end, the frame 24 and bearing base 10 have congruent contours. In addition, the frame 24 has several expansion slits 25 distributed over its periphery, which facilitate an expansion, in particular a temporary expansion for latching purposes. For insertion or latching, the lever 3 is pivoted into an actuated position on the bearing base 10, so as to pass through an opening 26 in the interior door paneling 20. A damper 30 inserted into the bearing base 10 dampens a closing motion of the lever 3.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment as contemplated herein. It should be understood that various changes may be made in the function and arrangement of elements described in an exemplary embodiment without departing from the scope of the invention as set forth in the appended claims.

1-15. (canceled)

16. An interior door opening mechanism for a motor vehicle door comprising:
a bearing base having an interface configured to detachably secure the interior door opening mechanism to an interior door panel of a motor vehicle door; and
a lever pivotally attached to the bearing base for actuating a door latch.

17. The interior door opening mechanism according to claim 16, wherein the bearing base is configured to be inserted from a rear side of the interior door panel.

18. The interior door opening mechanism according to claim 16, wherein the lever extends over the bearing base along a longitudinal direction when the lever is in an unactuated position.

19. The interior door opening mechanism according to claim 16, wherein the interface comprises at least one projection configured to establish a latched connection with the interior door panel of the motor vehicle door.

20. The interior door opening mechanism according to claim 16, wherein the interface comprises at least one guide rail extending in an insertion direction and configured to be received in a guide groove in the interior door panel.

21. An interior door panel assembly for a motor vehicle door comprising:
an interior door panel having an opening formed therein and a frame circumscribing the opening on a rear side of the interior door panel, wherein the frame includes a first locking interface;
an interior door opening mechanism including a bearing base received within the opening and having a second locking interface detachably coupling the interior door opening mechanism to the interior door panel, and a lever accessible from a front side of the interior door panel opposite the rear side and pivotally attached to the bearing base for actuating a door latch.

22. The interior door panel assembly according to claim 21, wherein the lever extends over the bearing base along a longitudinal direction when the lever is in an unactuated position.

23. The interior door panel assembly according to claim 21, wherein the second locking interface comprises at least one projection establishing a latched connection with the interior door panel of the motor vehicle door.

24. The interior door panel assembly according to claim 21, wherein the second interface comprises at least one guide rail extending in an insertion direction received in a guide groove in the interior door panel.

25. The interior door panel assembly according to claim 21, wherein the first locking interface includes at least one latching depression and the second locking interface includes at least one latching projection cooperating to establish a detachably latched connection between the interior door panel and the interior door opening mechanism.

26. The interior door panel assembly according to claim 25, wherein the first locking interface includes at least one guide groove and the second locking interface includes at least one guide rail extending in the insertion direction and received in the at least one guide groove.

27. The interior door panel assembly according to claim 25, wherein the first locking interface further comprises at least one stop in the insertion direction configured to engage the bearing base and positively position the interior door operating mechanism in the opening of the interior door panel.

28. The interior door panel assembly according to claim 21, wherein frame comprises at least one expansion joint formed therein.

29. An interior door panel assembly for a motor vehicle door comprising:
an interior door panel having an opening formed therein and a frame circumscribing the opening on a rear side of the interior door panel, wherein the frame includes a plurality of latching depressions arranged around the opening, and a guide groove formed therein;
an interior door opening mechanism including a bearing base received within the opening, a lever accessible from a front side of the interior door panel opposite the rear side and pivotally attached to the bearing base with a bearing axle for actuating a door latch, a plurality of projecting extending from the bearing base and a guide rail on the bearing base, wherein the guide rail is slidably received in the guide groove and each of the plurality of projections are received in an associated one of the plurality of latching depressions to detachably couple the interior door opening mechanism to the interior door panel.

30. The interior door panel assembly according to claim 29, wherein the frame further comprises an expansion slot formed therein.
